(19) United States
(12) Patent Application Publication
(10) Pub. No.: US 2018/0276719 A1
(43) Pub. Date: Sep. 27, 2018

(54) METHOD AND DEVICE FOR DETERMINING AREA OF MESSAGE OPERATION REGION AND ELECTRONIC DEVICE

(71) Applicant: BEIJING KINGSOFT INTERNET SECURITY SOFTWARE CO., LTD., Beijing (CN)

(72) Inventor: Ming Xu, Beijing (CN)

(73) Assignee: BEIJING KINGSOFT INTERNET SECURITY SOFTWARE CO., LTD., Beijing (CN)

(21) Appl. No.: 15/991,437

(22) Filed: May 29, 2018

Related U.S. Application Data
(63) Continuation of application No. PCT/CN2016/106301, filed on Nov. 17, 2016.

(30) Foreign Application Priority Data
Nov. 30, 2015 (TW) 201510856865.2

(51) Int. Cl. G06Q 30/02; H04L 29/08

(52) U.S. Cl. CPC G06Q 30/0276; H04L 67/303; G06Q 30/0242

(57) ABSTRACT

A method and a device for determining an area of a message operation region and an electronic device are provided. The method includes the followings. A first total delivery amount and a first user amount are acquired (S101). According to the first total delivery amount and the first user amount, a first conversion rate is calculated (S102). A display area of the preset operation region on the terminal interface is adjusted, and a second total delivery amount and a second user amount are acquired (S103). According to the second total delivery amount and the second user amount, a second conversion rate is calculated (S104). According to the first conversion rate and the second conversion rate, an area of an operation region of the recommendation information on the terminal interface is determined (S105).

### CROSS REFERENCE TO RELATED APPLICATION

This application is a continuation of International Application No. PCT/CN2016/106301, filed Nov. 17, 2016, which claims priorities to and benefits of Chinese Patent Application Serial No. 201510856865.2, filed with the State Intellectual Property Office of P. R. China on Nov. 30, 2015, by BEIJING KINGSOFT INTERNET SECURITY SOFTWARE CO., LTD., and titled with “METHOD, AND DEVICE FOR DETERMINING AREA OF MESSAGE DISPLAY REGION”, the entire contents of which are incorporated herein by reference.

### FIELD

The present disclosure relates to a field of electronic technology, and more particularly, to a method, a device for determining an area of a message operation region and an electronic device.

### BACKGROUND

With development of Internet technology, access to information through the Internet for life, entertainment and work has become part of people's lives. In order to increase popularity and promote products, businesses often deliver advertisement through the Internet.

### SUMMARY

Embodiments of the present disclosure provide a method for determining an area of a message operation region, including:
when a recommendation message is delivered to a plurality of terminals to be displayed in a preset operation region on a terminal interface of each of the plurality of terminals, acquiring a first total delivery amount of the recommendation message and a first user amount of users choosing to operate on content of the recommendation message;
calculating a first conversion rate for the recommendation message in the preset operation region according to the first total delivery amount and the first user amount;
adjusting a display area of the preset operation region on the terminal interface, and acquiring a second total delivery amount of the recommendation message and a second user amount of users choosing to operate on content of the recommendation message when the recommendation message is re-delivered to the plurality of terminals to be displayed in an adjusted preset operation region on the terminal interface of each of the plurality of terminals;
calculating a second conversion rate for the recommendation message in the adjusted preset operation region according to the second total delivery amount and the second user amount; and
determining an area of an operation region of the recommendation message on the terminal interface according to the first conversion rate and the second conversion rate.

Embodiments of the present disclosure provide an electronic device, including: a processor, a memory, a communication interface and a bus;
in which the processor, the memory and the communication interface are connected to and communicate with each other via the bus;
the memory is configured to store executable program codes; and
the processor is configured to run programs corresponding to the executable program codes by reading the executable program codes stored in the memory, to:
when a recommendation message is delivered to a plurality of terminals to be displayed in a preset operation region on a terminal interface of each of the plurality of terminals, acquire a first total delivery amount of the recommendation message and a first user amount of users choosing to operate on content of the recommendation message;
calculate a first conversion rate for the recommendation message in the preset operation region according to the first total delivery amount and the first user amount;
adjust a display area of the preset operation region on the terminal interface, and acquire a second total delivery amount of the recommendation message and a second user amount of users choosing to operate on content of the recommendation message when the recommendation message is re-delivered to the plurality of terminals to be displayed in an adjusted preset operation region on the terminal interface of each of the plurality of terminals;
calculate a second conversion rate for the recommendation message in the adjusted preset operation region according to the second total delivery amount and the second user amount; and
determine an area of an operation region of the recommendation message on the terminal interface according to the first conversion rate and the second conversion rate.

Embodiments of the present disclosure provide storage medium, configured to store an application, in which the application is configured to:
when a recommendation message is delivered to a plurality of terminals to be displayed in a preset operation region on a terminal interface of each of the plurality of terminals, acquire a first total delivery amount of the recommendation message and a first user amount of users choosing to operate on content of the recommendation message;
calculate a first conversion rate for the recommendation message in the preset operation region according to the first total delivery amount and the first user amount;
adjust a display area of the preset operation region on the terminal interface, and acquire a second total delivery amount of the recommendation message and a second user amount of users choosing to operate on content of the recommendation message when the recommendation message is re-delivered to the plurality of terminals to be displayed in an adjusted preset operation region on the terminal interface of each of the plurality of terminals;
calculate a second conversion rate for the recommendation message in the adjusted preset operation region according to the second total delivery amount and the second user amount; and
determine an area of an operation region of the recommendation message on the terminal interface according to the first conversion rate and the second conversion rate.

### BRIEF DESCRIPTION OF THE DRAWINGS

In order to further clearer describe technical solutions of embodiments of the present disclosure, simply descriptions will be made to drawings necessitated by describing embodiments of the present disclosure. Obviously, the drawings described below are merely some embodiments of the present disclosure, and other drawings may be obtained by those skilled in the art without any inventive labors according to these drawings.

FIG. 1 is a flow chart illustrating Embodiment One of a method for determining an area of a message operation region provided in the present disclosure;

FIG. 2 is a schematic diagram displaying a terminal interface provided in embodiments of the present disclosure.

FIG. 3 is a flow chart illustrating Embodiment Two of a method for determining an area of a message operation region provided in the present disclosure;

FIG. 4 is a block diagram illustrating a device for determining an area of a message operation region provided in embodiments of the present disclosure;

FIG. 5 is a block diagram illustrating an area determining module of a device provided in embodiments of the present disclosure; and

FIG. 6 is a block diagram illustrating an electronic device provided in embodiments of the present disclosure.

### DETAILED DESCRIPTION

Clear and complete descriptions will be made to technical solutions of embodiments of the present disclosure with reference to drawings of embodiments of the present disclosure. Obviously, the described embodiments are merely parts of embodiments instead of all embodiments of the present disclosure. Based on the embodiments illustrated in the present disclosure, other embodiments obtained by those skilled in the art without any inventive labor are all covered by the scope of the present disclosure.

In prior art solutions, an advertisement recommendation is implemented by modeling based on a basic profile of a user and an individual's click action on the advertisement. In order to notify the user of the advertisement timely, the advertisement may be delivered on a to-be-unlocked interface of a terminal. However, an operation region for locking the interface is limited. If an area of a region where the advertisement is provided is too small, the advertisement is not easy to attract attention. If the area of the region where the advertisement is too large, an area of a to-be-unlocked operation region is relatively reduced, easily causing accidental operations. Therefore, it is necessary to provide a method to select a suitable area of the operation region for delivering messages.

Embodiments of the present disclosure provide a method and a device for determining an area of a message operation region and an electronic device. Without influences on functional operations by a user, a precise configuration to the area of the message operation region is realized, reducing accidental operations.

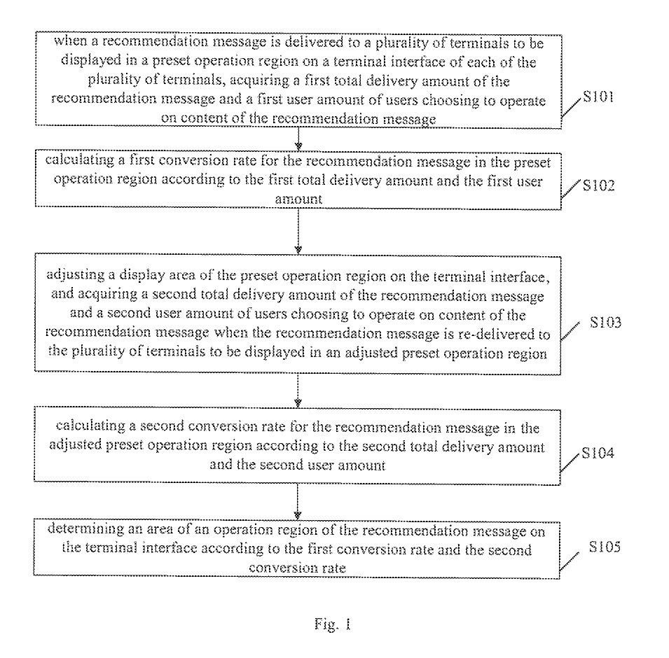

Referring to FIG. 1, FIG. 1 is a flow chart illustrating Embodiment One of a method for determining an area of a message operation region provided in the present disclosure. As illustrated in FIG. 1, the method provided in embodiments of the present disclosure includes the following.

In block S101, when a recommendation message is delivered to a plurality of terminals to be displayed in a preset operation region on a terminal interface of each of the plurality of terminals, a first total delivery amount of the recommendation message and a first user amount of users choosing to operate on content of the recommendation message are acquired.

In concrete implementations, the recommendation message may be sent to the plurality of terminals, and the recommendation message may be displayed in the preset operation region on the terminal interface of each of the plurality of terminals. An amount of terminals on which the recommendation message is displayed in the preset operation region is acquired as the first total delivery amount of the recommendation message. When users click the recommendation message displayed in the preset operation region on the terminal interface to perform an actual operation, an operation record of each user is acquired, and the first user amount is obtained by performing a statistic on the operation records of the users.

In block S102, a first conversion rate for the recommendation message in the preset operation region is calculated according to the first total delivery amount and the first user amount.

In concrete implementations, a first quotient is obtained by dividing the first user amount by the first total delivery amount. The first quotient is determined as the first conversion rate for the recommendation message in the preset operation region. For example, the first total delivery amount of the recommendation message is 1 million. When 12 thousand users clicks the recommendation message and 10 thousand users among the 12 thousand users perform an actual operation on the content of the recommendation message, it is determined that the first user amount is 10 thousand, and the click operations by other users on the recommendation message are accidental operations. The first conversion rate for the recommendation message in the preset operation region is 1% (dividing 10 thousand by 1 million).

In block S103, a display area of the preset operation region on the terminal interface is adjusted, and a second total delivery amount of the recommendation message and a second user amount of users choosing to operate on content of the recommendation information are acquired when the recommendation message is re-delivered to the plurality of terminals to be displayed in an adjusted preset operation region on the terminal interface of each of the plurality of terminals.

In concrete implementations, the display area of the preset operation region on the terminal interface may be increased, or the display area of the preset operation region on the terminal interface may be decreased. In addition, when the recommendation message is re-delivered to the plurality of terminals to be displayed in the adjusted preset operation region on the terminal interface of each of the plurality of terminals, the second total delivery amount of the recommendation message and the second user amount of users choosing to operate on the content of the recommendation message may be acquired by employing a same way as the block S101. In other words, the amount of terminals on which the recommendation message is displayed in the adjusted preset operation region is acquired as the second total delivery amount. When users click the recommendation message displayed in the adjusted preset operation region on the terminal interface to perform an actual operation, an operation record of each user is acquired, and the first user amount is obtained by performing a statistic on the operation records of the users.

Optionally, a position of a slide-to-unlock region on the terminal interface of each of the plurality of terminals is determined. The display area of the preset operation region on the terminal interface is adjusted according to the position of the slide-to-unlock region. In detail, when the display area of the preset operation region on the terminal interface is adjusted, it needs to guarantee that a distance between the preset operation region and the slide-to-unlock region is greater than a predetermined threshold. When the distance between the preset operation region and the slide-to-unlock region is not greater than the predetermined threshold, it is easy to cause an accidental operation when sliding to unlock.

In block S104, a second conversion rate for the recommendation message in the adjusted preset operation region is calculated according to the second total delivery amount and the second user amount.

In concrete implementations, a value may be obtained by dividing the second user amount by the second total delivery amount. The value is determined as the second conversion for the recommendation message in the adjusted preset operation region.

In block S105, an area of an operation region of the recommendation message on the terminal interface of each of the plurality of terminals is determined according to the first conversion rate the second conversion rate.

In concrete implementations, the first conversion rate may be compared with the second conversion rate. The area of the operation region of the recommendation message on the plurality of terminal interfaces is determined according to a comparison result of comparing the first conversion rate with the second conversion rate.

Further, when the display area of the preset operation region is increased, if the first conversion rate equals to the second conversion rate, it is determined that the area of the operation region is the display area of the preset operation region. Alternatively, when the display area of the preset operation region is increased, if the first conversion rate is smaller than the second conversion rate, it is determined that the area of the operation region is an increased display area of the preset operation region.

In addition, when the display area of the preset operation region is decreased, if the first conversion rate is greater than the second conversion rate, it is determined that the area of the operation region is the display area of the preset operation region. Alternatively, when the display area of the preset operation region is decreased, if the first conversion rate equals to the second conversion rate, it is determined that the area of the operation region is a decreased display area of the preset operation region.

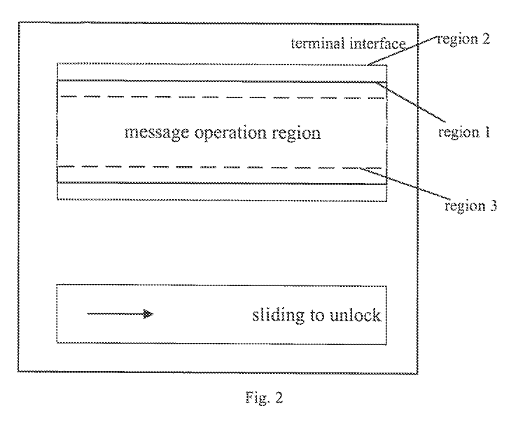

For example, as illustrated in FIG. 2, the terminal interface includes the message operation region and the slide-to-unlock region, and the area of region 2>the area of region 1>the area of region 3. The recommendation message may be delivered to the region 1 firstly, and a conversion rate 1 for the recommendation message in the region 1 may be calculated. The region 1 is increased to obtain the region 2. A conversion rate 2 for the recommendation message in the region 2 is calculated. If the conversion rate 1 equals to the conversion rate 2, an area of the region 1 may be selected as the area of the operation region of the recommendation message. If the conversion rate 1 is smaller than the conversion rate 2, an area of the region 2 may be selected as the area of the operation region of the recommendation message. In addition, the region 1 may be decreased to obtain the region 3. A conversion rate 3 for the recommendation message in the region 3 is calculated. If the conversion rate 1 equals to the conversion rate 3, an area of the region 3 may be selected as the area of the operation region of the recommendation message. If the conversion rate 1 is greater than the conversion rate 3, an area of the region 1 may be selected as the area of the operation region of the recommendation message.

Optionally, configuration information of the area of the operation region is sent to the plurality of terminals, such that the plurality of terminals display the recommendation message based on the area of the operation region.

Optionally, the position of the slide-to-unlock region on the terminal interface of each of the plurality of terminals is determined. The display area of the preset operation region on the terminal interface is adjusted according to the position of the slide-to-unlock region on the terminal interface. In detail, when the display area of the preset operation region on the terminal interface of each of the plurality of terminals is adjusted, it needs to guarantee that the distance between the preset operation region and the slide-to-unlock region is greater than a predetermined threshold. If the distance between the preset operation region and the slide-to-unlock region is not greater than the predetermined threshold, it is easy to cause an accidental operation when sliding to unlock.

When the recommendation message is delivered to the plurality of terminals to be displayed in the preset operation region on the terminal interface of each of the plurality of terminals, the first total delivery amount of the recommendation message and the first user amount of the users choosing to operate on the content of the recommendation message are acquired. According to the first total delivery amount and the first user amount, the first conversion rate is calculated for the recommendation message in the preset operation region. The display area of the preset operation region on the terminal interface is adjusted, and the second total delivery amount of the recommendation message and the second user amount of users choosing to operate on the content of the recommendation message are acquired when the recommendation message is re-delivered to the plurality of terminals to be displayed in the adjusted preset operation region on the terminal interface of each of the plurality of terminals. According to the second total delivery amount and the second user amount, the second conversion rate is calculated for the recommendation message in the adjusted preset operation region. According to the first conversion rate and the second conversion rate, the area of the operation region of the recommendation message on the terminal interface is determined. Without influences on functional operations of the user, a precise configuration to the area of the message operation region is realized, thereby reducing accidental operations.

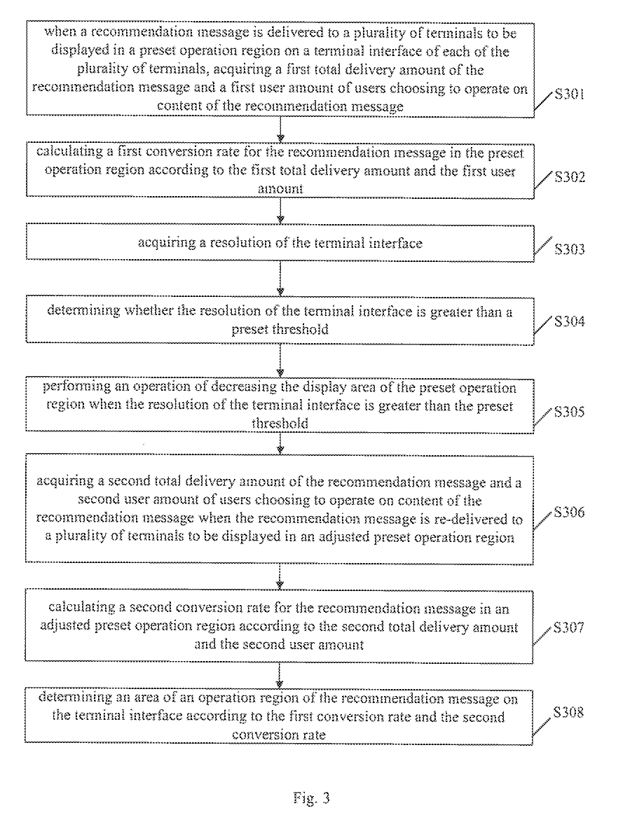

Referring to FIG. 3, FIG. 3 is a flow chart illustrating Embodiment Two of a method for determining an area of a message operation region provided in the present disclosure. As illustrated in FIG. 3, the method in embodiments of the present disclosure includes the followings.

In block S301, when a recommendation message is delivered to a plurality of terminals to be displayed in a preset operation region on a terminal interface of each of the plurality of terminals, a first total delivery amount of the recommendation message and a first user amount of users choosing to operate on content of the recommendation message are acquired.

In concrete implementations, the recommendation message may be sent to the plurality of terminals and may be displayed on the preset operation region on the terminal interface of each of the plurality of terminals. The amount of terminals on which the recommendation message is displayed in the preset operation region is acquired as the first total delivery amount of the recommendation message. When users click the recommendation message displayed in the preset operation region on the terminal interface and perform an actual operation, an operation record of each user is acquired. A statistic is performed on the operation records of the users to obtain the first user amount.

In block S302, a first conversion rate for the recommendation message in the preset operation region is calculated according to the first total delivery amount and the first user amount.

In concrete implementations, the first user amount may be divided by the first total delivery amount to obtain a first quotient. The first quotient may be determined as the first conversion rate for the recommendation message in the preset operation region. For example, the first total delivery amount of the recommendation message is 1 million. When 12 thousand users clicks the recommendation message and 10 thousand users among the 12 thousand users perform an actual operation on the content of the recommendation message, it is determined that the first user amount is 10 thousand, and the click operations by other users on the recommendation message are accidental operations. The first conversion rate for the recommendation message in the preset operation region is 1% (dividing 10 thousand by 1 million).

In block S103, a resolution of the terminal interface of each of the plurality of terminals is acquired.

In block S304, it is determined whether the resolution of terminal interface is greater than a preset threshold. The preset threshold may be 1920*1080, but is not limited thereto.

In block S305, if it is determined that the resolution of the terminal interface is greater than the preset threshold, the display area of the preset operation region on the terminal interface is decreased. If it is determined that the resolution of the terminal interface is not greater than the preset threshold, the method ends at this block. It is to be illustrated that, since the resolution of the terminal interface is too small, it is unsuitable to decrease the display area of the preset operation region.

Optionally, a position of a slide-to-unlock region on the terminal interface of the plurality of terminals is determined. The display area of the preset operation region on the terminal interface of each of the plurality of terminals is adjusted according to the position of the slide-to-unlock region. In detail, when the display area of the preset operation region on the terminal interface is adjusted, it needs to guarantee that a distance between the preset operation region and the slide-to-unlock region is greater than a predetermined threshold. When the distance between the preset operation region and the slide-to-unlock region is not greater than the predetermined threshold, it is easy to cause an accidental operation when sliding to unlock.

In block S306, a second total delivery amount of the recommendation message and a second user amount of users choosing to operate on content of the recommendation message are acquired when the recommendation message is re-delivered to the plurality of terminals to be displayed in a decreased preset operation region on the terminal interface of each of the plurality of terminals. The second total delivery amount of the recommendation message and the second user amount of users choosing to operate on the content of the recommendation message may be acquired by employing a same way as the block S301.

In block S307, a second conversion rate for the recommendation message in the decreased preset operation region is calculated according to the second total delivery amount and the second user amount.

In concrete implementations, the second user amount may be divided by the second total delivery amount to obtain a value. The value may be determined as the second conversion rate for the recommendation message in an adjusted preset operation region.

In block S308, an area of an operation region of the recommendation message on the terminal interface of each of the plurality of terminals is determined according to the first conversion rate and the second conversion rate.

In concrete implementations, the first conversion rate may be compared with the second conversion rate. The area of the operation region of the recommendation message on the terminal interface is determined according to a comparison result of comparing the first conversion rate with the second conversion rate.

Further, when the display area of the preset operation region is decreased, when the first conversion rate is greater than the second conversion rate, it is determined that the area of the operation region is the display area of the preset operation region. Alternatively, when the display area of the preset operation region is decreased, if the first conversion rate equals to the second conversion rate, it is determined that the area of the operation region is a decreased display area of the preset operation region.

Optionally, configuration information of the area of the operation region is sent to the plurality of terminals, such that the plurality of terminals display the recommendation message based on the area of the operation region.

In embodiments of the present disclosure, when the recommendation message is delivered to the plurality of terminals to be displayed in the preset operation region on the terminal interface of each of the plurality of terminals, the first total delivery amount of the recommendation message and the first user amount of the users choosing to operate on the content of the recommendation message are acquired. According to the first total delivery amount of the first user amount, the first conversion rate is calculated for the recommendation message in the preset operation region. The display area of the preset operation region on the terminal interface is adjusted, and the second total delivery amount of the recommendation message and the second user amount of users choosing to operate on the content of the recommendation message are acquired when the recommendation message is re-delivered to the plurality of terminals to be displayed in the adjusted preset operation region on the terminal interface of each of the plurality of terminals. According to the second total delivery amount and the second user amount, the second conversion rate is calculated for the recommendation message in the adjusted preset operation region. According to the first conversion rate and the second conversion rate, the area of the operation region of the recommendation message on the terminal interface is determined. Without influences on functional operations of a user, a precise configuration to the area of the message operation region is realized, thereby reducing accidental operations.

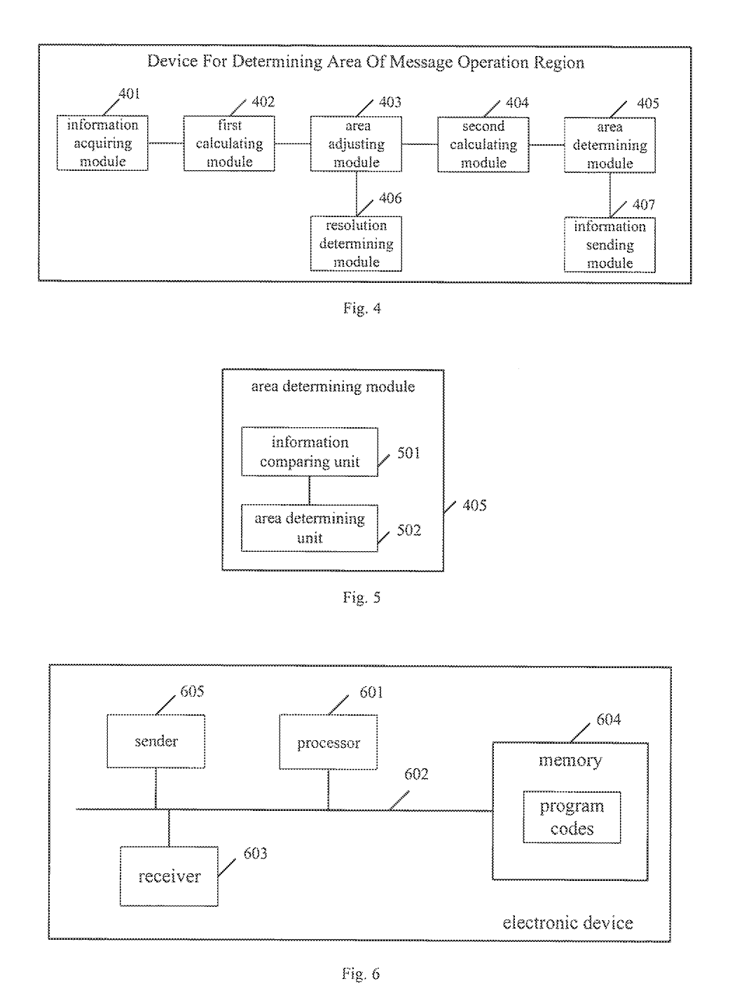

Referring to FIG. 4, FIG. 4 is a block diagram illustrating a device for determining an area of a message operation region provided in embodiments of the present disclosure. As illustrated in FIG. 4, the device provided in embodiments of the present disclosure includes an information acquiring module 401, a first calculating module 402, an area adjusting module 403, a second calculating module 404 and an area determining module 405.

The information acquiring module 401 is configured to acquire a first total delivery amount of a recommendation message and a first user amount of users choosing to operate on content of the recommendation message, when the recommendation message is delivered to a plurality of terminals to be displayed in a preset operation region on a terminal interface of each of the plurality of terminals.

In concrete implementations, the recommendation message may be sent to the plurality of terminals, and the recommendation message may be displayed in the preset operation region on the terminal interface of each of the plurality of terminals. An amount of terminals on which the recommendation message is displayed in the preset operation region is acquired as the first total delivery amount of the recommendation message. When users click the recommendation message displayed in the preset operation region on the terminal interface to perform an actual operation, an operation record of each user is acquired, and the first user amount is obtained by performing a statistic on the operation records of the users.

The first calculating module 402 is configured to calculate a first conversion rate for the recommendation message in the preset operation region according to the first total delivery amount and the first user amount.

In concrete implementations, a first quotient is obtained by dividing the first user amount by the first total delivery amount. The first quotient is determined as the first conversion rate for the recommendation message in the preset operation region. For example, the first total delivery amount of the recommendation message is 1 million. When 12 thousand users clicks the recommendation message and 10 thousand users among the 12 thousand users perform an actual operation on the content of the recommendation message, it is determined that the first user amount is 10 thousand, and the click operations by other users on the recommendation message are accidental operations. The first conversion rate for the recommendation message in the preset operation region is 1% (dividing 10 thousand by 1 million).

The area adjusting module 403 is configured to adjust a display area of the preset operation region on the terminal interface, and to acquire a second total delivery amount of the recommendation message and a second user amount of users choosing to operate on content of the recommendation message when the recommendation message is re-delivered to the plurality of terminals to be displayed in an adjusted preset operation region on the terminal interface of each of the plurality of terminals.

In concrete implementations, the display area of the preset operation region on the terminal interface may be increased, or the display area of the preset operation region on the terminal interface may be decreased. In addition, when the recommendation message is re-delivered to the plurality of terminals to be displayed in the adjusted preset operation region on the terminal interface of each of the plurality of terminals, the second total delivery amount of the recommendation message and the second user amount of users choosing to operate on the content of the recommendation message may be acquired by employing a same way as the information acquiring module 401.

Optionally, a position of a slide-to-unlock region on the terminal interface of each of the plurality of terminals is determined. The display area of the preset operation region on the terminal interface is adjusted according to the position of the slide-to-unlock region. In detail, when the display area of the preset operation region on the terminal interface is adjusted, it needs to guarantee that a distance between the preset operation region and the slide-to-unlock region is greater than a predetermined threshold. When the distance between the preset operation region and the slide-to-unlock region is not greater than the predetermined threshold, it is easy to cause an accidental operation when sliding to unlock.

The second calculating module 404 is configured to calculate a second conversion rate for the recommendation message in the adjusted preset operation region according to the second total delivery amount and the second user amount.

In concrete implementations, a value may be obtained by dividing the second user amount by the second total delivery amount. The value is determined as the second conversion for the recommendation message in the adjusted preset operation region.

The area determining module 405 is configured to determine an area of an operation region of the recommendation message on the terminal interface according to the first conversion rate and the second conversion rate.

In concrete implementations, as illustrated in FIG. 5, the area determining module 405 further includes an information comparing unit 501 and an area determining unit 502.

The information comparing unit 501 is configured to compare the first conversion rate with the second conversion rate.

The area determining unit 502 is configured to determine the area of the operation region of the recommendation message on the terminal interface according to a comparison result of comparing the first conversion rate with the second conversion rate.

In concrete implementations, when the display area of the preset operation region is increased, if the first conversion rate equals to the second conversion rate, it is determined that the area of the operation region is the display area of the preset operation region. Alternatively, when the display area of the preset operation region is increased, if the first conversion rate is smaller than the second conversion rate, it is determined that the area of the operation region is an increased display area of the preset operation region.

In addition, when the display area of the preset operation region is decreased, if the first conversion rate is greater than the second conversion rate, it is determined that the area of the operation region is the display area of the preset operation region. Alternatively, when the display area of the preset operation region is decreased, if the first conversion rate equals to the second conversion rate, it is determined that the area of the operation region is a decreased display area of the preset operation region.

For example, as illustrated in FIG. 2, the terminal interface includes the message operation region and the slide-to-unlock region, and the area of region 2>the area of region 1>the area of region 3. The recommendation message may be delivered to the region 1 firstly, and a conversion rate 1 for the recommendation message in the region 1 may be calculated. The region 1 is increased to obtain the region 2. A conversion rate 2 for the recommendation message in the region 2 is calculated. If the conversion rate 1 equals to the conversion rate 2, an area of the region 1 may be selected as the area of the operation region of the recommendation message. If the conversion rate 1 is smaller than the conversion rate 2, an area of the region 2 may be selected as the area of the operation region of the recommendation message. In addition, the region 1 may be decreased to obtain the region 3. A conversion rate 3 for the recommendation message in the region 3 is calculated. If the conversion rate 1 equals to the conversion rate 3, an area of the region 3 may be selected as the area of the operation region of the recommendation message. If the conversion rate 1 is greater than the conversion rate 3, an area of the region 1 may be selected as the area of the operation region of the recommendation message.

Optionally, as illustrated in FIG. 4, the device provided in embodiments of the present disclosure may further include a resolution determining module 406.

The resolution determining module 406 is configured to acquire a resolution of the terminal interface; determine whether the resolution of the terminal interface is greater than a preset threshold; and perform an operation of decreasing the display area of the preset operation region of the area adjusting module 403 when the resolution of the terminal interface is greater than the preset threshold.

Optionally, as illustrated in FIG. 4, the device provided in embodiments of the present disclosure may further include an information sending module 407.

The information sending module 407 is configured to send configuration information of the area of the operation region to the plurality of terminals, such that the plurality of terminals display the recommendation message based on the area of the operation region.

In embodiments of the present disclosure, when the recommendation message is delivered to the plurality of terminals to be displayed in the preset operation region on the terminal interface of each of the plurality of terminals, the first total delivery amount of the recommendation message and the first user amount of the users choosing to operate on the content of the recommendation message are acquired. According to the first total delivery amount and the first user amount, the first conversion rate is calculated for the recommendation message in the preset operation region. The display area of the preset operation region on the terminal interface is adjusted, and the second total delivery amount of the recommendation message and the second user amount of users choosing to operate on the content of the recommendation message are acquired when the recommendation message is re-delivered to the plurality of terminals to be displayed in the adjusted preset operation region on the terminal interface of each of the plurality of terminals. According to the second total delivery amount and the second user amount, the second conversion rate is calculated for the recommendation message in the adjusted preset operation region. According to the first conversion rate and the second conversion rate, the area of the operation region of the recommendation message on the terminal interface is determined. Without influences on functional operations of the user, a precise configuration to the area of the message operation region is realized, thereby reducing accidental operations.

Referring to FIG. 6, FIG. 6 is a schematic diagram illustrating an electronic device provided in embodiments of the present disclosure. As illustrated in FIG. 6, the electronic device may include: at least one processor 601, such as CPU, at least one receiver 603, at least one memory 604, at least one sender 605, and at least one transmission bus 602. The at least one transmission bus 602 is configured to realize connection and communication among the above components. The at least one receiver 603 and the at least one sender 605 of the electronic device provided in embodiments of the present disclosure may be a wired sending port, or may be a wireless device, such as including an antenna device, configured to perform a signal or data communication with other node devices. The at least one memory 604 may be a high-speed RAM (random access memory), or may be a non-volatile memory, such as at least one magnetic disk memory. The at least one memory 604 may optionally further be at least one storage device away from the at least one processor 601. The at least one memory 604 has a set of program codes stored therein, and the processor 601 is configured to call the program codes stored in the memory, for executing the followings.

When a recommendation message is delivered to a plurality of terminals to be displayed in a preset operation region on a terminal interface of each of the plurality of terminals, a first total delivery amount of the recommendation message and a first user amount of users choosing to operate on content of the recommendation message are acquired.

A first conversion rate for the recommendation message in the preset operation region is calculated according to the first total delivery amount and the first user amount.

A display area of the preset operation region on the terminal interface is adjusted, and a second total delivery amount of the recommendation message and a second user amount of users choosing to operate on content of the recommendation message are acquired when the recommendation message is re-delivered to the plurality of terminals to be displayed in an adjusted preset operation region on the terminal interface of each of the plurality of terminals.

A second conversion rate for the recommendation message in the adjusted preset operation region is calculated according to the second total delivery amount and the second user amount.

An area of an operation region of the recommendation message on the terminal interface is determined according to the first conversion rate and the second conversion rate.

In some embodiments, the processor 601 may be further configured to execute the followings.

The first conversion rate is compared with the second conversion rate.

The area of the operation region of the recommendation message on the terminal interface is determined according to a comparison result of comparing the first conversion rate with the second conversion rate.

In some embodiments, the processor 601 may be further configured to execute the followings.

Determining the area of the operation region of the recommendation message on the terminal interface according to the comparison result of comparing the first conversion rate with the second conversion rate includes the followings.

When the display area of the preset operation region is increased, it is determined that the area of the operation region is the display area of the preset operation region if the first conversion rate equals to the second conversion rate.

Alternatively, when the display area of the preset operation region is increased, it is determined that the area of the operation region is an increased display area of the preset operation region if the first conversion rate is smaller than the second conversion rate.

In some embodiments, the processor 601 may be further configured to execute the followings.

Determining the area of the operation region for the recommendation message on the terminal interface according to the comparison result of comparing the first conversion rate with the second conversion rate includes the followings.

When the display area of the preset operation region is decreased, it is determined that the area of the operation region is the display area of the preset operation region if the first conversion rate is greater than the second conversion rate.

Alternatively, when the display area of the preset operation region is decreased, it is determined that the area of the operation region is a decreased display area of the preset operation region if the first conversion rate equals to the second conversion rate.

In some embodiments, the processor 601 may be further configured to execute the followings.

A resolution of the terminal interface is acquired.

It is determined whether the resolution of the terminal interface is greater than a preset threshold.

An operation of decreasing the display area of the preset operation region is performed when the resolution of the terminal interface is greater than the preset threshold.

In some embodiments, the processor 601 may be further configured to execute the followings.

The first user amount is divided by the first total delivery amount to obtain a first quotient.

The first quotient is determined as the first conversion rate for the recommendation message in the preset operation region.

In some embodiments, the processor 601 may be further configured to execute the followings.

The second user amount is divided by the second total delivery amount to obtain a second quotient.

The second quotient is determined as the second conversion rate for the recommendation message in the adjusted preset operation region.

In some embodiments, the processor 601 may be further configured to execute the followings.

Configuration information of the area of the operation region is sent to the plurality of terminals, such that the plurality of terminals display the recommendation message based on the area of the operation region.

In some embodiments, the processor 601 may be further configured to execute the followings.

A position of the slide-to-unlock region on the terminal interface of each of the plurality of terminals is determined.

The display area of the preset operation region on the terminal interface is adjusted according to the position of the slide-to-unlock region.

Accordingly, embodiments of the present disclosure provide a storage medium. The storage medium is configured to store an application. The application is configured to execute the method for determining an area of a message operation region according to embodiments of a first aspect of the present disclosure.

It is to be illustrated that, for each of the foregoing method embodiments, for the sake of simple description, they are all expressed as a series of action combinations, but those skilled in the art should know that the present disclosure is not limited by the described action sequence. Because according to the present disclosure, certain steps may be performed in other orders or simultaneously. In addition, those skilled in the art should also understand that embodiments described in the specification all belong to preferred embodiments, and the involved actions and modules are not necessarily required by the present disclosure.

In foregoing embodiments, description made to each embodiment has its own emphasis. For part that is not described in detail in an embodiment, reference may be made to the relevant description of other embodiments.

Those skilled in the art shall understand that all or parts of the steps in the above exemplifying method for the present disclosure may be achieved by commanding the related hardware with programs, the programs may be stored in a computer-readable storage medium. The storage medium may include: flash disk, read-only memory (ROM for short), random access memory (RAM for short), magnetic disk, optical disk or the like.

The method and a related device for determining an area of a message operation region and a related system provided by the embodiments of the present disclosure are described above in detail. Specific examples are used herein to describe the principles and embodiments of the present disclosure. The above embodiments are only used to understand the method according to the present disclosure and the key principle. Meanwhile, for those skilled in the art, according to the idea of the present disclosure, there will be changes in the specific implementation and the application scope. In conclusion, the content of this specification should not be understood as a limitation of the present disclosure.

In the description of the specification, descriptions of terms such as “an embodiment,” “some embodiments,” “an example,” “a specific example,” or “some examples,” mean that a particular feature, structure, material, or characteristic described in connection with the embodiment or example is included in at least one embodiment or example of the present disclosure. In this specification, exemplary descriptions of aforesaid terms are not necessarily referring to the same embodiment or example. Furthermore, the particular features, structures, materials, or characteristics may be combined in any suitable manner in one or more embodiments or examples. Moreover, without contradiction, those skilled in the art could combine different embodiments or different characteristics in embodiments or examples described in the present disclosure.

Moreover, terms of “first” and “second” are only used for purpose of description and cannot be seen as indicating or implying relative importance or indicating or implying the number of the indicated technical features. Thus, the features defined with “first” and “second” may include or imply at least one of these features. In the description of the present disclosure, the term “a plurality of” means at least two, such as two, three or the like, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, wherein the order of execution may differ from that which is depicted or discussed, including according to involved function, executing concurrently or with partial concurrence or in the contrary order to perform the function, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of acquiring the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer-readable medium comprise (a non-exhaustive list): an electronic connection (an electronic device) with one or more wires, a portable computer enclosure (a magnetic device), a random access memory (RAM), a read-only memory (ROM), an erasable programmable read-only memory (EPROM or a flash memory), an optical fiber device and a portable compact disk read-only memory (CDROM). In addition, the computer-readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method for the present disclosure may be achieved by commanding the related hardware with programs, the programs may be stored in a computer-readable storage medium, and the programs include one or a combination of the steps in the method embodiments of the present disclosure when running on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer-readable storage medium.

The storage medium mentioned above may be read-only memories, magnetic disks, CD, etc. Although embodiments of present disclosure have been shown and described above, it should be understood that above embodiments are just explanatory, and cannot be construed to limit the present disclosure, for those skilled in the art, changes, variations, alternatives, and modifications can be made to the embodiments within the scope of the present disclosure.

What is claimed is:

1. A method for determining an area of a message operation region, comprising:
when a recommendation message is delivered to a plurality of terminals to be displayed in a preset operation region on a terminal interface of each of the plurality of terminals, acquiring a first total delivery amount of the recommendation message and a first user amount of users choosing to operate on content of the recommendation message;
calculating a first conversion rate for the recommendation message in the preset operation region according to the first total delivery amount and the first user amount;
adjusting a display area of the preset operation region on the terminal interface, and acquiring a second total delivery amount of the recommendation message and a second user amount of users choosing to operate on content of the recommendation message when the recommendation message is re-delivered to the plurality of terminals to be displayed in an adjusted preset operation region on the terminal interface of each of the plurality of terminals;
calculating a second conversion rate for the recommendation message in the adjusted preset operation region according to the second total delivery amount and the second user amount; and
determining an area of an operation region of the recommendation message on the terminal interface according to the first conversion rate and the second conversion rate.

2. The method according to claim 1, wherein determining the area of the operation region of the recommendation message on the terminal interface according to the first conversion rate and the second conversion rate comprises:
comparing the first conversion rate with the second conversion rate; and
determining the area of the operation region of the recommendation message on the terminal interface according to a comparison result of comparing the first conversion rate with the second conversion rate.

3. The method according to claim 2, wherein, adjusting the display area of the preset operation region on the terminal interface comprises increasing the display area of the preset operation region; and
determining the area of the operation region of the recommendation message on the terminal interface according to the comparison result of comparing the first conversion rate with the second conversion rate comprises:
when increasing the display area of the preset operation region, determining that the area of the operation region is the display area of the preset operation region if the first conversion rate equals to the second conversion rate; or
when increasing the display area of the preset operation region, determining that the area of the operation region is an increased display area of the preset operation region if the first conversion rate is smaller than the second conversion rate.

4. The method according to claim 2, wherein adjusting the display area of the preset operation region on the terminal interface comprises decreasing the display area of the preset operation region; and
determining the area of the operation region for the recommendation message on the terminal interface according to the comparison result of comparing the first conversion rate with the second conversion rate comprises:
when decreasing the display area of the preset operation region, determining that the area of the operation region is the display area of the preset operation region if the first conversion rate is greater than the second conversion rate; or
when decreasing the display area of the preset operation region, determining that the area of the operation region is a decreased display area of the preset operation region if the first conversion rate equals to the second conversion rate.

5. The method according to claim 4, wherein, before determining the area of the operation region of the recommendation message on the terminal interface according to the comparison result of comparing the first conversion rate with the second conversion rate, the method further comprises:
acquiring a resolution of the terminal interface;
determining whether the resolution of the terminal interface is greater than a preset threshold; and
performing an operation of decreasing the display area of the preset operation region when the resolution of the terminal interface is greater than the preset threshold.

6. The method according to claim 1, wherein, calculating the first conversion rate for the recommendation message in the preset operation region according to the first total delivery amount and the first user amount comprises:
dividing the first user amount by the first total delivery amount to obtain a first quotient; and
determining the first quotient as the first conversion rate for the recommendation message in the preset operation region.

7. The method according to claim 1, wherein, calculating the second conversion rate for the recommendation message in the adjusted preset operation region according to the second total delivery amount and the second user amount comprises:
dividing the second user amount by the second total delivery amount to obtain a second quotient; and
determining the second quotient as the second conversion rate for the recommendation message in the adjusted preset operation region.

8. The method according to claim 1, wherein, after determining the area of the operation region for the recommendation message on the terminal interface according to the first conversion rate and the second conversion rate, the method further comprises:
sending configuration information of the area of the operation region to the plurality of terminals, such that the plurality of terminals display the recommendation message based on the area of the operation region.

9. The method according to claim 1, wherein, the terminal interface comprises a slide-to-unlock region, and adjusting the display area of the preset operation region on the terminal interface comprises:
determining a position of the slide-to-unlock region on the terminal interface of each of the plurality of terminals; and
adjusting the display area of the preset operation region on the terminal interface according to the position of the slide-to-unlock region.

10. An electronic device, comprising a processor, a memory, a communication interface and a bus; wherein
the processor, the memory and the communication interface are connected to and communicate with each other via the bus;
the memory is configured to store executable program codes; and
the processor is configured to run programs corresponding to the executable program codes by reading the executable program codes stored in the memory, to:
when a recommendation message is delivered to a plurality of terminals to be displayed in a preset operation region on a terminal interface of each of the plurality of terminals, acquire a first total delivery amount of the recommendation message and a first user amount of users choosing to operate on content of the recommendation message;
calculate a first conversion rate for the recommendation message in the preset operation region according to the first total delivery amount and the first user amount;
adjust a display area of the preset operation region on the terminal interface, and acquire a second total delivery amount of the recommendation message and a second user amount of users choosing to operate on content of the recommendation message when the recommendation message is re-delivered to the plurality of terminals to be displayed in an adjusted preset operation region on the terminal interface of each of the plurality of terminals;
calculate a second conversion rate for the recommendation message in the adjusted preset operation region according to the second total delivery amount and the second user amount; and
determine an area of an operation region of the recommendation message on the terminal interface according to the first conversion rate and the second conversion rate.

11. A storage medium, configured to store an application, wherein the application is configured to:
when a recommendation message is delivered to a plurality of terminals to be displayed in a preset operation region on a terminal interface of each of the plurality of terminals, acquire a first total delivery amount of the recommendation message and a first user amount of users choosing to operate on content of the recommendation message;
calculate a first conversion rate for the recommendation message in the preset operation region according to the first total delivery amount and the first user amount;
adjust a display area of the preset operation region on the terminal interface, and acquire a second total delivery amount of the recommendation message and a second user amount of users choosing to operate on content of the recommendation message when the recommendation message is re-delivered to the plurality of terminals to be displayed in an adjusted preset operation region on the terminal interface of each of the plurality of terminals;
calculate a second conversion rate for the recommendation message in the adjusted preset operation region according to the second total delivery amount and the second user amount; and
determine an area of an operation region of the recommendation message on the terminal interface according to the first conversion rate and the second conversion rate.

12. The electronic device according to claim 10, wherein the processor is configured to run programs corresponding to the executable program codes by reading the executable program codes stored in the memory, to:
compare the first conversion rate with the second conversion rate; and
determine the area of the operation region of the recommendation message on the terminal interface according to a comparison result of comparing the first conversion rate with the second conversion rate.

13. The electronic device according to claim 12, wherein the processor is further configured to run programs corresponding to the executable program codes by reading the executable program codes stored in the memory, to:
increase the display area of the preset operation region;
when the display area of the preset operation region is increased, determine that the area of the operation region is the display area of the preset operation region if the first conversion rate equals to the second conversion rate; or
when the display area of the preset operation region is increased, determine that the area of the operation region is an increased display area of the preset operation region if the first conversion rate is smaller than the second conversion rate.

14. The electronic device according to claim 12, wherein the processor is further configured to run programs corresponding to the executable program codes by reading the executable program codes stored in the memory, to:
decrease the display area of the preset operation region;
when the display area of the preset operation region is decreased, determine that the area of the operation region is the display area of the preset operation region if the first conversion rate is greater than the second conversion rate; or
when the display area of the preset operation region is decreased, determine that the area of the operation region is a decreased display area of the preset operation region if the first conversion rate equals to the second conversion rate.

15. The electronic device according to claim 14, wherein the processor is further configured to run programs corresponding to the executable program codes by reading the executable program codes stored in the memory, to:
acquire a resolution of the terminal interface;
determine whether the resolution of the terminal interface is greater than a preset threshold; and
perform an operation of decreasing the display area of the preset operation region when the resolution of the terminal interface is greater than the preset threshold.

16. The electronic device according to claim 10, wherein the processor is further configured to run programs corresponding to the executable program codes by reading the executable program codes stored in the memory, to:
divide the first user amount by the first total delivery amount to obtain a first quotient; and
determine the first quotient as the first conversion rate for the recommendation message in the preset operation region.

17. The electronic device according to claim 10, wherein the processor is further configured to run programs corresponding to the executable program codes by reading the executable program codes stored in the memory, to:
divide the second user amount by the second total delivery amount to obtain a second quotient; and
determine the second quotient as the second conversion rate for the recommendation message in the adjusted preset operation region.

18. The electronic device according to claim 10, wherein the processor is further configured to run programs corresponding to the executable program codes by reading the executable program codes stored in the memory, to:
send configuration information of the area of the operation region to the plurality of terminals, such that the plurality of terminals display the recommendation message based on the area of the operation region.

19. The electronic device according to claim 10, wherein the processor is further configured to run programs corresponding to the executable program codes by reading the executable program codes stored in the memory, to:
determine a position of the slide-to-unlock region on the terminal interface of each of the plurality of terminals; and
adjust the display area of the preset operation region on the terminal interface according to the position of the slide-to-unlock region.
